(19) United States
(12) Patent Application Publication
(10) Pub. No.: US 2010/0316875 A1
(43) Pub. Date: Dec. 16, 2010

(54) FLEXIBLE EPOXY-BASED COMPOSITIONS

(76) Inventor: Alain H. Lamon, Maisons-Laffitte (FR)

Correspondence Address: 3M INNOVATIVE PROPERTIES COMPANY, PO BOX 33427, ST. PAUL, MN, 55133-3427, US

(21) Appl. No.: 12/677,021

(22) PCT Filed: Sep. 2, 2008
(86) PCT No.: PCT/US08/75028

§ 371 Date: Mar. 8, 2010

(30) Foreign Application Priority Data
Sep. 14, 2007 (GB) 0717867.6

(51) Int. Cl. B32B 25/00; C08L 83/00; C08L 47/00; C08K 3/22; C08L 63/00; B32B 21/08

(52) U.S. Cl. 428/413; 525/101; 525/105; 524/437

(57) ABSTRACT

Precursor composition for room-temperature curable compositions comprising a first component (A) separated from a second component (B), the component (A) comprising one or more nitrile-butadiene rubber and a linear long chain diamine and the component (B) comprising an epoxy resin and a silicone resin or a resin comprising epoxy and silicone resins.

### CROSS-REFERENCE TO RELATED APPLICATION

This application claims priority to Great Britain Patent Application No. 0717867.6, filed Sep. 14, 2007, the disclosure of which is incorporated by reference herein in its entirety.

### TECHNICAL FIELD

In the following there are provided curable precursor compositions for the preparation of flexible epoxy-based compositions. The cured compositions are suitable as sealants. Also provided are methods of preparing the precursor and flexible compositions.

### BACKGROUND

Adhesive materials that can be cured to form flexible compositions, e.g. compositions having great elasticity and good internal strength, are desirable for applications where the surfaces to which the adhesive materials are supplied are subjected to forces, e.g. force created by cycles of expansion and contraction of the surfaces, for example, due to exposure of the surface to weather (heat and/or humidity). Other applications include sealing (caulking) applications of surfaces that are subjected to sanding or polishing, for example, for providing smooth or homogeneous looking surfaces. Such surfaces include, for example, surfaces employed in buildings or other structures, furniture, or vehicles, such as, for example, motor vehicles, air craft or water craft.

In typical caulking applications, in particular for wooden surfaces, such as, for example, timber marine deckings, adhesive compositions based on polyurethanes have been employed. These moisture-curing one-component systems may form upon curing flexible elastomers that have a sufficient inner strength to allow sanding of the material. Being moisture-curable PUR-based sealants suffer from the disadvantage of having varying curing times and degrees of quality depending on the ambient moisture. This may be in particular relevant for the treatment of (large) external surfaces.

In US Patent Application No 2006111502 a hot melt caulking composition is described based on carboxylic acid components and amine components. The compositions are reported to have good flexibility and sufficient strength making them suitable for sanding. However, these compositions are hot melt compositions and require heat and special equipment to be applied to the surface. This might be an inconvenience in particular when treating large surfaces.

Therefore, there has been a need to provide alternative adhesive compositions having a high flexibility when cured but also sufficient strength and resistance for being suitable as sealants.

### SUMMARY

In one aspect there is provided a precursor composition for a composition that is curable at 25° C. said precursor comprising a first component (A) separated from a second component (B),

wherein the component (A) comprises
(a1) one or more nitrile-butadiene rubbers, and
(a2) one or more curing agents according to the general formula

R¹R²N—R³—NR⁴H

wherein R¹, R² and R⁴ represent, independently from each other, hydrogen, a linear or branched alkyl or a linear or branched polyoxyalkyl moiety, and wherein R³ represents a linear or branched alkyl, alkylamine, alkylether or polyoxyalkyl residue having at least 5 carbon atoms, and wherein component (B) comprises
(b1) an epoxy resin comprising one or more repeating units derived from a dihydric arene; and
(b2) a silicone resin.

In another aspect there is provided a precursor composition for preparing a composition that is curable at 25° C. said precursor comprising a first component (A) separated from a second component (B),

wherein the component (A) comprises
(a1) one or more nitrile-butadiene rubbers, and
(a2) one or more curing agents according to the general formula

R¹R²N—R³—NR⁴H
wherein R¹, R² and R⁴ represent, independently from each other, hydrogen, a linear or branched alkyl or a linear or branched polyoxyalkyl moiety, and wherein R³ represents a linear or branched alkyl, alkylamine, alkylether or polyoxyalkyl residue having at least 5 carbon atoms,

wherein component (B) comprises
(b1) a silicone resin that has been modified with one or more epoxy resins.

In yet another aspect there is provided a curable composition that when cured at 168 h at ambient conditions yields a composition having an elongation at break at ambient conditions of at least 100%, said curable composition comprising the components a1, a2, b1 and b2 as defined in any one of claims 1 to 4 and wherein ambient conditions are 23° C. +/−2° C. and 50%+/−5% humidity.

In yet another aspect there is provided a surface comprising a composition having an elongation at break at ambient conditions of at least 100% said composition comprising the components (a1), (a2), (b1) and (b2) as described above.

In a further aspect there is provided a method of preparing an epoxy-based composition having an elongation at break of greater than 100% at ambient conditions, said method comprising
(i) curing a room-temperature curable mixture comprising effective amounts of (a1), (a2), (b1) and (b2), wherein (a1), (a2), (b1), (b2) are defined as above and wherein ambient conditions are 23° C.+/−2° C. and 50%+/−5% humidity.

### DETAILED DESCRIPTION

In one aspect there are provided heat-curable compositions that already cure at room temperature. The curable compositions are epoxy resin-based compositions which comprise as part of the epoxy-resin or as a separate resin one or more silicone resins. The curable compositions provide good bonding to surfaces, in particular (external surfaces) that may be employed in buildings and vehicles, in particular surfaces comprising (or consisting of) wood. Curable means the composition can be cross-linked. Cross-linking results in an increase of physical properties, e.g. an increase in Shore A hardness, viscosity, tensile strength and/or tear strength. The curing process can be observed by monitoring one or all of these physical properties over time. The curing process is complete (the sample is fully cured) when these parameters no longer measurably increase.

The cured compositions provided herein are flexible. For example, the compositions may be bent without breaking. The cured compositions are highly elastic and may have at ambient conditions an elongation at break of greater than 100% or even greater than 120%. Furthermore, the precursor compositions may be formulated such that the resulting cured composition may in addition also have a tensile strength of greater than 0.5 MPa, or greater than 1.8 MPa and/or have a shore A hardness of greater than about 55.

Typically, the compositions may be formulated to have when cured a tensile strength of from about 0.5 to about 7.5 MPa and/or an elongation at break of from about 100% or 120% up to 950%, and/or a Shore A hardness of from about 55 to about 95.

The compositions are suitable as sealants, in particular, as sealants for weather-exposed surfaces. The compositions are also suitable as adhesives, in particular those where the adhesive bond is required to be flexible.

Preferred surfaces are those comprising or consisting of wood, in particular teak wood.

In another aspect there are provided curable compositions which when cured yield the compositions described above. The curable compositions may be used as adhesive compositions and/or as sealant precursors.

In yet another aspect there are provided precursor compositions for preparing the curable or cured compositions described above. The precursor compositions are two-component compositions, comprising a first component A, separated from a second component B. Both components may have a low viscosity so that the curable composition obtained by combining component A and B may be applied to the surface at room temperature.

Component A of the two component composition is the hardening composition. It contains one or more curing agents that cross-link the curable resin(s) comprised in component B.

The curing agent is a specific amine as described below that contributes to the elastic properties of the cured composition.

In addition to the one or more epoxy resins, component B also comprises a silicone resin. In some embodiments, the silicone and epoxy resins, may be part of one and the same resin, for example they may be copolymers. In some embodiments, the silicone resin may be modified with one or more epoxy resins or vice versa as will be described in detail below.

The composition further contains a toughening agent contributing to the tensile and tear strength of the cured composition. The toughening agent is a butadiene-nitrile rubber.

Both components A and B may further comprise one or more catalysts for accelerating the curing reaction. Both components may also comprise adjuvants, such as, for example, fillers and rheology controlling agents, such as reactive diluents, to adjust the viscosity of the components and of the curable composition after combining part A and B.

The amounts of reactive epoxy and amine containing ingredients in A and B are chosen such that when A and B are combined, the reactive amine groups are at least present in equal amounts but preferably in excess based on the molar amounts of the reactive epoxy groups.

Typically, the curable compositions provided herein may comprise from 10 to 40 phr silicone resin. The curable composition may generally comprise from 30 to 150 phr curing agent. The curable composition may also comprise from 10 to 150 phr butadiene-nitrile rubber.

The composition may further comprise from 0 to 15 phr of one or more adhesion promoters. The composition may also comprise from 0 to 30 phr of one or more catalysts.

The composition may further comprise from 0 to 200 phr of one or more pigments and/or from 0 to 200 phr of one or more fillers.

As used herein, “phr” means parts per 100 parts of epoxy resins in the curable composition (i.e. the total amount of epoxy in A and B).

In one embodiment the component A comprises

30 to 40% of curing agent
30 to 40% of toughening agent
0 to 10% of catalyst
0 to 30% of filler, wherein the ingredients are chosen to add up to 100%.

In this embodiment component B comprises

5-35% (or 15 to 25%) silicone resin
20-40% (or 25 to 35%) epoxyresin
10-25% (or 15 to 20%) diluent
10-25% (or 18 to 22%) filler
0-10% catalyst, wherein the ingredients are chosen to add up to 100%.

In case of embodiments where the silicone and epoxy resin are one and the same resin, the weight ranges for epoxy resin and silicone resin refer to the silicone and epoxy monomers of that resin.

Preferably, the filler includes an aluminium tri hydrate and/or silica

In the following the ingredients will be described in greater detail.

Epoxy resins. Epoxy resins useful in the compositions of the present disclosure include those derived from epoxy-functionalised monomers such as monomers containing one or more monofunctional or multifunctional glycidyl ethers.

Typical epoxy resins include glycidyl ethers of dihydric arenes, aliphatic diols or cycloaliphatic diols. Glycidyl ethers of aliphatic diols include linear or branched polymeric epoxides having one or more terminal epoxy groups such as, e.g., diglycidyl ethers of polyoxyalkylene glycols.

Examples of aromatic glycidyl ethers include, but are not limited to, those that can be prepared by reacting a dihydric arene with an excess of epichlorohydrin. Dihydric arenes, as referred to herein, are arenes having two hydrogen atoms available for a reaction with epichlorhydrin. Examples of useful dihydric arenes include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Preferred examples of epoxy resins include those having one or more repeating units derivable from bisphenol A, bisphenol F or both. Other preferred examples of epoxy resins include those that can be prepared by bisphenol A, bisphenol F or both with epichlorohydrine. The epoxy resins may have a molecular weight in the range of from about 170 to about 10,000, preferably from about 200 to about 3,000 g/mol. The average epoxy functionality in the resin is typically greater than 1 and less than 4. Novolak-type resins may also be employed.

Examples of commercially available aromatic and aliphatic epoxides useful in the invention include diglycidylether of bisphenol A (e.g. available under the tradename EPON 828, EPON 1001, EPON 1310 and EPON 1510 from Hexion Specialty Chemicals GmbH, Rosbach, Germany, and DER-331, DER-332, and DER-334 available from Dow Chemical Co,); diglycidyl ether of bisphenol F (e.g. EPICLON 830) available from Dainippon Ink and Chemicals, Inc.); and flame retardant epoxy resins (e.g. DER 580, a brominated bisphenol type epoxy resin available from Dow Chemical Co.).

The epoxy resins may also be part of the silicone resins described below, for example, as a comonomer, a core-shell polymer (e.g. as the shell of the core-shell polymer, wherein the core comprises a silicone resin) or a block polymer or a graft polymer.

Silicone resins. As used herein, the term silicone resins refers to resin containing one or more repeating siloxane units. The silicone resins may be homopolymers, copolymers, core-shell polymers or graft polymers (block polymers). The silicone resins may be monomodal, bimodal or multimodal, with respect to molecular weight distribution or particle size distribution. Typically, the silicone resins may have an average particle size or from 0.1 to 50 μm.

Typically, siloxane units have the general formula

—[(R1R2)Si—O]n-

wherein R1 and R2 are different or identical organic residues and n is a number greater than 1.

For example, R1 and R2 may represent independently a radical, which can be a linear or branched (preferably saturated) alkyl group with 1 to 18 C atoms, a cycloaliphatic group with 4 to 8 C atoms, or a phenyl or alkylphenyl group. R1 or R2 may also represent polyether- or polyolefin groups. Preferably at least one of R1 or R2 is an alkyl groups, such as, for example, methyl, ethyl, propyl, butyl, pentyl, heptyl, hexyl etc. or a phenyl or alkyl phenyl group.

The silicone resin may also be modified with one or more epoxy resins, for example those described above. Therefore the epoxy-modified polysiloxanes may contain one or more units or repeating units derived from one or more epoxy-functionalised monomers.

Preferably the one or more epoxy-functionalised monomers are aromatic glycidyl ethers (including diglycidyl ethers). Aromatic glycidyl ethers include, but are not limited to, those that can be prepared by reacting a dihydric arene with an excess of epichlorohydrin as described above. Preferred aromatic glycidyl ethers include but are not limited to bisphenol glycidyl ethers, wherein the bisphenol is preferably bisphenol A, bisphenol F or a combination thereof.

The epoxy-modified silicone resin may be a polysiloxane cross-linked with one or more epoxy resins as described above. For example epoxy-modified polysiloxanes may be those where one or more epoxy resins are grafted onto one or more polysiloxane resins. The epoxy-modified polysiloxane may also be a block-copolymer comprising polysiloxane units and epoxy resin units, such as those derived from one or more epoxy-functionalised monomer as described above. The epoxy-modified polysiloxane may also be a core-shell polymer. Such core-shell polymers may have, for example, a polysiloxane core and a shell comprising one or more epoxy resins or they may have an epoxy resin as a core and a shell comprising polysiloxanes. The epoxy resins may be derived from epoxy-functionalised monomers as described above.

The silicone resins may also comprise one or more reactive epoxy-residues, for example a terminal epoxide such as a terminal glycidyl ether. In particular in embodiments, where no other epoxy resins than an epoxy-modified silicone resin is used, the epoxy-modified silicone resins have sufficient amounts of reactive epoxy-groups to provide an adhesive composition of appropriate cross-linkage.

Examples of epoxy-modified polysiloxanes are described, for instance, in U.S. Pat. No. 4,853,434 or in Adv. Polymer Sci. 72 (1985), pp 80 to 108 (which are incorporated herein by reference) and are commercially available, for example, under the tradename ‘ALBIDUR’ from Hanse Chemie, Geesthacht, Germany.

The silicone resin may also be dispersed in an epoxy resin.

Toughening agents. The composition further comprises one or more toughening agents. Suitable toughening agents include butadiene-(acrylo)nitrile rubbers (BNR). BNRs are copolymers comprising repeating units derived from 1,2-butadiene and/or 1,3 butadiene and a nitrile-function containing olefin, such as e.g. 2-propenenitrile (acrylonitrile).

Typical BNRs have a Brookfield viscosity (at 27° C.) of greater 80 000 and less than 600 000 Pa·s. Preferably the BNRs have a low viscosity (such as a Brookfield viscosity of from about 100 000 to about 300 000 Pa·s at 27° C.). The BNRs may be solid or liquid at ambient conditions. The butadiene acrylonitrile rubber is preferably amine-terminated. Suitable BNRs are commercially available, for example, under the tradename Hycar™ from Emerald Performance Materials.

Curing agents (hardeners). Curing agents suitable in the present invention are primary or secondary linear or branched long-chain amines, with primary amines being preferred. Preferably, the curing agent has a molecular weight of greater than about 150 g/mol, for example between 200 and 700 g/mol. Typically, the curing agent has a molecular weight of less than 3000 g/mol.

Examples of suitable curing agent include those according to the general formula

R¹R²N—R³—NR⁴H (I)

wherein R¹, R² and R⁴ represent, independently from each other, hydrogen, a linear or branched alkyl or a linear or branched polyoxyalkyl moiety.

The residues R¹, R², R⁴ may contain a hydrocarbon containing about 1 to 25 carbon atoms or a polyether containing from 3 to 25 carbon atoms. Preferably, one, more preferably two and most preferably all residues R¹, R² and R⁴ are hydrogen.

R³ represents a linear or branched alkyl, alkylamine, polyaminoalkyl, polyamidoalkyl, alkylether or polyoxyalkyl residue having at least 5 carbon atoms.

Preferably, R³ is a polyether and the curing agent is a polyetheramine or polyetherdiamine including those polyetheramines that can be derived from polypropyleneoxide or polyethylenoxide. R³ may also be a polyamidoamine or a polyamidodiamine including those that can be derived by reacting a dimer or trimer carboxylic acid with a polyetheramine.

Suitable polyetheramines that can be used include but are not limited to those corresponding to the general formula

H₂N—C₃H₆—O—[C₂H₄—O-]nC₃H₆—NH₂ (II)

H₂N—C₃H₆—O—[C₃H₆—O-]nC₃H₆—NH₂ (III)

H₂N—C(CH₃)H—CH₂-[O—CH₂—C(CH₃)H]n—O—CH₂—CH(CH₃)—NH₂ (IV)

with n being between 1 and 34 (inclusive), such as for example 1, 2, 3, 4, 5, or between 1 and 2 (such as for example 1.5 or 1.7), between 2 and 3 (such as for example 2.5 or 2.7), between 3 and 4 (e.g. 3.5 or 3.7), between 4 and 5 (e.g. 4.5 or 4.7), or n being 31, 32, 33 or between 31 and 33.

Suitable amines are available under the tradename PC AMINE DA from Nitroil, Germany or under the tradename JEFFAMINE from Huntsman, Belgium. A particular preferred curing agent is 4,7,10-trioxamidecane-1,13-diamine (TTD). TTD is commercially available, for example, from BASF or Nitroil.

Combinations of curing agents, for example, a combination of two or more polyetherdiamines are also suitable. A preferred combination contains at least one curing agent according to formula (II), (III) or (IV).

The one or more curing agents may be present in an amount from about 10 to about 50% wt, preferably from about 15 to about 45% wt based either on the total amount of part A or based on the amount of the total composition (A+B). In some embodiments, the curing agents may be present in the total composition at greater than their stoichiometric ration, i.e., the curing agents may be present in a molar ratio of —NH2 functionalities to epoxy functionalities of >1.0 (typically from 1.10 to 1.30).

Metal salt catalysts. In further embodiments there are provided compositions that comprise in addition to the curing agent one or more metal salt catalysts for accelerating the curing. Suitable catalysts which are operable in the present compositions include the group I metals, group II metals or lanthanoid salts wherein the anion is selected from nitrates, iodides, thiocyanates, triflates, alkoxides, perchlorates and sulfonates. Nitrates, iodides, thiocyanates, triflates and sulfonates including their hydrates being preferred and nitrates, including their hydrates, such as for example calcium nitrates, being particularly preferred.

The preferred group I metal (cation) is lithium and the preferred group II metals are calcium and magnesium with calcium being especially preferred. Accordingly, preferred catalyst salts are lanthane nitrate, lanthane triflate, lithium iodide, lithium nitrate, calcium nitrate and their corresponding hydrates. For most applications, the catalyst will be used from about 0.05 to less than 15% wt based on the total weight of the total composition. The catalyst may be present in part A or part B or both and may be present in an amount from about 0.05 to 10% wt based on the total amount of part B or in an amount of from 0.05 to about 10% wt based on the total amount of part A.

Fillers. The compositions may further comprise one or more fillers, such as, for example, one or more of the following ingredients: reactive diluents, rheology controlling agents, adhesion promoters, pigments, flame retardants, anti-oxidants, UV-protecting agents. The optimum amounts of fillers depend on the amounts and characteristics of the other ingredients present in component A, B or in the total curable composition. Optimum amounts can be identified through routine experiments for example, by measuring the Brookfield viscosity of A, B or the curable composition, or the characteristics of the cured composition.

Reactive diluents. Reactive diluents may be added to control the flow characteristics of the adhesive composition. Preferably, the diluents are part of component B. Suitable diluents can have at least one reactive terminal end portion and, preferably, a saturated or unsaturated cyclic backbone. Preferred reactive terminal ether portions include glycidyl ether. Examples of suitable diluents include the diglycidyl ether of resorcinol, diglycidyl ether of cyclohexane dimethanol, diglycidyl ether of neopentyl glycol, diglycidylether of 1,4 butanediol, diglycidylether of 1,6 hexanediol, triglycidyl ether of trimethylolpropane. Commercially available reactive diluents include, for example, ‘Reactive Diluent 107’ from Hexion, The Netherlands, ‘Epodil 757’ from Air Products, Allentown, Pa., USA, ‘Epilox™ P13-26’ from Leuna Harze, Germany.

The optimum amounts of diluents depend on the amounts and characteristics of the other ingredients present in component B or in the total composition. Optimum amounts can be identified through routine experiments for example, by measuring the Brookfield viscosity of component B.

Rheology-controlling agents. Typical examples of rheology controlling agents include but are not limited to silica-gels, Ca-silicates, phosphates, molybdates, fumed silica, clays such as bentonite or wollastonite, organo-clays, aluminium-trihydrates, hollow-glass-microspheres; hollow-polymeric microspheres and calcium-carbonate. Commercially available rheology controlling agents, include, for example: SHIELDEX AC5 (Grace Davison, Columbia, Md./USA), a synthetic amorphous silica, calcium hydroxide mixture; CAB-O-SIL TS 720 (Cabot GmbH, Hanau, Germany), hydrophobic fumed silica-treated with polydimethyl-siloxane-polymer; glass-beads class IV (250-300 microns), Micro-billes de verre 180/300 (CVP S.A., France); glass bubbles K37 (3M Deutschland GmbH, Neuss, Germany), MINSIL SF 20 (Minco Inc., 510 Midway, Tenn., USA), amorphous silica; APYRAL 24 ESF (Nabaltec GmbH, Schwandorf, Germany) amorphous, fumed silica;

AEROSIL™ R.202 (Degussa, Germany), treated fumed silica. Rheology-controlling agents may be present in A, B or in A and B.

Flame retardants. Examples of flame retardants include, but are not limited to, aluminium trihydrates, or magnesium hydroxides. Examples of commercially available products include Portaflame SG40 (Ankerpoort, the Netherlands), aluminium trihydrate, epoxysilane-functionalized (2 wt %) aluminium trihydrate. Flame retardants may be present in A, B or in A and B.

Pigments. Pigments may include inorganic or organic pigments. Typical examples include but are not limited to ferric oxide, brick dust, carbon black, titanium oxide and the like. Pigments may be present in A, B or in A and B.

Adhesion promoters. Adhesion promoters may include, for example, silane-containing compounds. An example of a commercially available adhesion promoter includes SILANE Z-6040 (γ-glycidoxypropyl-trimethoxysilane) (DOW-Corning, Seneffe, Belgium). Adhesion promoters may be present in A, B or in A and B. Preferably, the adhesion promoter is present is B.

The precursor composition may be contained in cartridges and converted into the curable composition for example by extruding the two components simultaneously through a shared nozzle. The precursor composition may be applied at room temperature.

The application of the precursor composition or curable composition to the desired surface can be carried out using, for example, manual applicators or air-powered applicators. Manual and air-powered applicators are available, for example, as EPX manual or EPX air-powered applicators from 3M Company, St. Paul, Minn., USA.

Curing may be carried out a room temperature. Heat may be optionally applied but application of heat is not necessary. The composition may be applied to the surface in single or multiple layers. After curing the composition may be sanded.

In some embodiments, the precursor compositions and curable compositions provided herein are suitable for applications where flexible adhesives or sealing materials are required. In some embodiments, the compositions described herein not only have good elasticity but also good cohesive strength and may be applied to seal or protect surfaces or articles or for bonding materials that are exposed to mechanical forces.

In some embodiments, the precursor compositions can be cured to compositions having good enough strength to be sanded, e.g. the cured compositions may not smear when being sanded. Sanding may be required for providing smooth or homogeneous looking surfaces.

In some embodiments, the cured compositions provide a water barrier and/or humidity barrier and are suitable sealants.

Surfaces to which the compositions may be applied include, for example, those employed in architecture, buildings (e.g. window frames, floor panels etc), furniture, or vehicles, such as, for example, motor vehicles, air craft or water craft (e.g. timber marine deckings). In particular, the compositions may be applied to external surfaces, i.e. weather-exposed surfaces. Typical surfaces are those comprising or consisting essentially of wood. Examples include but are not limited, teak, oak, birch, cherry, mahogany, acacia or particle boards.

Also provided herein are articles or surfaces that have been treated with the curable composition.

Further provided are methods of preparing an epoxy-based composition having an elongation at break of greater than 100% at ambient conditions as described above and additionally also has one or more or all of the parameters tensile strength, tear strength or shore A hardness as described above.

Said methods comprise curing a room-temperature curable mixture comprising effective amounts of (a1), (a2), (b1) and (b2), wherein (a1), (a2), (b1), (b2) are defined as above. The mixture may contain one or more of the adjuvants described above.

The mixture may be prepared by combining effective amounts of the components. Preferably the ingredients are used in amounts as described above but adjuvants may be added in effective amounts to fine-tune the rheological properties of the mixture and/or the cured composition. Preferably, the mixture also contains a pigment, a rheology controlling agent, a diluent and a flame retardant.

After or during the mixing the mixture is applied to the relevant surface. Curing can be carried out at ambient conditions for a sufficient time until the desired physical parameters are achieved. Curing speed depends on the presence of curing catalysts and on the temperature applied. Increased temperature and/or the presence of catalysts will increase the curing speed. The properties will be achieved after curing for 168 hours at ambient conditions.

Ambient conditions as referred to above are 23° C.+/−2° C. and 50%+/−5% humidity.

The following examples are provided to further illustrate the invention provided, without intending to limit the invention thereto.

### Methods

Extrusion Rate. The processability of the base (part B) and hardener (part A) of a curable epoxy-based composition was evaluated by extruding it through standard equipment using the following procedure. An air driven application gun (available from SEMCO, East Kilbride, U.K.) was fitted with a 150 ml disposable cartridge and a nozzle having an aperture of 5 mm. The disposable cartridge was filled with the material to be tested. By applying an air pressure of 5 bars the material was extruded at ambient temperature (23° C.+/−2° C.). The extrusion rate was determined by measuring the quantity (mass of material in g) extruded per time unit (sec.). The extrusion rate was measured 3 times and the results averaged.

Brookfield viscosity. The viscosity was measured according to ASTM D 2196-05 using a RVF model equipped with an No. 7 spindle running at 2 RPM. Viscosity was measured at 23+/−2° C. (unless specified otherwise) and expressed in Pa·s [Pascal·seconds].

Tensile and Elongation. The tensile and elongation properties of the cured epoxy-based composition were measured according to the test procedure described in ASTM D.438-00 using a Type V specimen cut from a cured 3 mm thick sheet of cured material. The epoxy-based composition was allowed to cure at room temperature (23° C. +/−2° C.) and a humidity of 50+/−5% for 7 days prior to testing.

Testing was performed using an Instron Tensile Tester Model 1122 at a speed of 50 mm/min. Tensile strength in MPa and elongation at break in % were recorded for each sample. A total of 6 measurements per sample were performed and the results averaged.

Tear Strength. Tear strength of the cured epoxy-based composition was measured according to DIN 53515 using a Type V specimen cut from a cured 3 mm thick sheet of cured material. The test samples were allowed to cure at room temperature (23° C. +/−2° C.) and a humidity of 50+/−5% for 7 days prior to testing. Testing was performed using an Instron Tensile Tester Model 1122 at a speed of 50 mm/min. Tear strength was recorded for each sample in N/mm. A total of 6 measurements per sample were performed and the results averaged.

Shore A Hardness (Scales A and/or D). The Shore Hardness was measured according to ASTM D 2240. The hardness was recorded at room temperature (23° C.+/−2° C.). A total of 6 measurements per sample were performed and the results averaged.

### LIST OF MATERIALS

| | |
|---|---|
| Silicone resin | Albidur ™ EP2240A, silicone modified with bisphenol A |
| | epoxy resin (comprising about 40% wt of silicone resin), |
| | Hanse Chemie, Geesthacht, Germany |
| Epoxy Resin | Araldite ™ XB4122, modified DGEBA resin, Huntsman |
| | Advanced Materials, Belgium |
| Epoxy Resin | Epikote 828, DGEBA resin, Hexion, The Netherlands |
| Epoxy Diluent | Epilox ™ P13-26, diglycidyl ether of |
| | cyclohexanedimethanol, Leuna Harze, Germany |
| Toughener | Hycar ™ ATBN 1300x 16, amine terminated butadiene |
| | acrylonitrile polymer, Emerald Performance Materials, USA |
| Flame-retardant | Portaflame SG40, aluminium tri-hydrate, Ankerpoort, The |
| | Netherlands |
| Catalyst | Tetra hydrated calcium nitrate, VWR, France |
| Adhesion Promoter | Silane Z.6040, γ-glycidoxy propyl trimethoxy silane, Dow |
| | Corning, USA |
| Rheology Control | Aerosil ™ R.202, treated fumed silica, Degussa, Germany |
| Curing agent | TTD (4,7,10 trioxatridecane 1,13-diamine) BASF, Germany |
| Comparative curing agent | TETA, triethylene tetramine, DEH24 from Dow Chemicals, |
| | Germany |
| Comparative curing agent | N-AEP, N-amino ethyl piperazine, DEH39 from Dow |
| | Chemicals, Germany |
| Curating agent | Ancamid A.910, a polymeric diamine, Air Products & |
| | Chemicals, USA |
| Comparative curing agent | Versamid 140, polyamino-imidazoline, Cognis, Italy |
| Pigment | Raven ™ 1125P, carbon black, Columbian Carbon, USA |

DGEBA = diglycidyl ether of bisphenol A

### Preparation of Hardener Formulation (Component A) as Carried Out in Experiments 1 to 4

The ingredients used for preparing component A are shown in table 1 below.

A heated planetary type mixer with high shear turbine made by Rayneri, Italy was used for processing the hardener formulation according to the following steps:

TTD and Ancamid A.910 were charged into the preheated mixer (110-120° C.) and mixed until homogeneous (approximately 15 min). Hydrated calcium nitrate was added and mixed for 60 min until homogenously dispersed in the melt (visual inspection). After cooling down to 50-55° C. the nitrile rubber was added and mixed for 60 min. The fillers were added and mixed under vacuum (−0, 90 at) for 60 minutes to get an air and bubble free material.

TABLE 1

| | Experiment | | | | |
|---|---|---|---|---|---|
| | 1 | 2 | 3 | 4 | 5 |
| Component B | phr | Phr | phr | phr | Phr |
| | (epoxy | (epoxy resin) | (epoxy | (epoxy | (epoxy resin) |
| | resin) | | resin) | resin) | |
| Albidur | 70.0 | 70.0 | 70.0 | 70.0 | 70.0 |
| EP2240-A | | | | | |
| Araldite | 23.0 | 23.0 | 23.0 | 23.0 | 23.0 |
| XB4122 | | | | | |
| Epilox P13-26 | 35.0 | 35.0 | 35.0 | 35.0 | 35.0 |
| Z6040 silane | 3.0 | 3.0 | 3.0 | 3.0 | 3.0 |
| Aerosil R202 | 3.0 | 3.0 | 3.0 | 3.0 | 3.0 |
| Portaflame | 50.0 | 50.0 | 50.0 | 50.0 | 50.0 |
| SG40 | | | | | |
| Raven 1155P | 6.0 | 6.0 | 6.0 | 6.0 | 6.0 |
| Ca(NO3)2 × | 10 | 10 | 10 | 10 | 10 |
| 4H2O | | | | | |

### Preparation of Base Formulation (Component B) as Carried Out in Experiments 1 to 4

The ingredients used for preparing component B are shown in table 2 below.

A heated planetary type mixer with high shear turbine made by Rayneri, Italy was used for processing the base formulation according to the following steps:

The epoxy resins were charged into the preheated mixer (80-85° C.) and mixed until homogeneous (approximately 15 min). Hydrated calcium nitrate was added and mixed for 60 min until homogeneously dispersed in the melt (visual inspection). After cooling down to 50-55° C. the filler materials were added and mixed for 30 minutes. The epoxysilane was added and mixed under vacuum (−0, 90 at) for 60 min to get an air and bubble-free material.

### Preparation of Curable Composition (A+B) as Carried Out in Experiments 1 to 4

The curable compositions were prepared by combining 100 parts by volume (or 88 parts by weight) of A with 50 parts by volume or 50 parts by weight) of B.

### Preparation of Cured Compositions

A sample of the curable compositions was applied the sample holders used in the corresponding test method. The sample was cured for 168 h at ambient conditions (i.e. 23° C.+/−2° C. and 50% humidity (+/−5%). These particular curing conditions were chosen for demonstrative purposes only. The compositions provided herein may be cured much faster.

The properties of the cured compositions are shown in table 3.

TABLE 2
Examples 2, 4 and 5 are comparative examples

| | Experiment | | | | |
|---|---|---|---|---|---|
| | 1 | 2 | 3 | 4 | 5 |
| Component A | Phr | Phr | Phr | Phr | Phr |
| | (curing | (curing | (curing | (curing | (curing agent) |
| | agent) | agent) | agent) | agent) | |
| Ancamid A.910 | 120 | — | — | — | — |
| Hycar ATBN | 120 | 120 | 120 | 120 | 120 |
| 1300 × 16 | | | | | |
| Ca(NO3)2 × | 12 | — | — | — | — |
| 4H2O | | | | | |
| Aerosil R202 | 3 | 2 | 2 | 2 | 2 |
| Portaflame | 75 | — | — | — | — |
| SG40 | | | | | |
| TTD | 10 | — | 29 | — | — |
| TETA | | 14 | | | |
| N-AEP | | | | 22 | |
| Versamid | | | | | 80 |

TABLE 3

| Experiment | 1 | 2 | 3 | 4 | 5 |
|---|---|---|---|---|---|
| Tensile (MPa) | 3.0 | 6.8 | 3.1 | 5.7 | 7.3 |
| Elongation (%) | 175 | 56 | 141 | 83 | 91 |
| Tear Strength (N/mm) | 3.9 | 6.1 | 7.3 | 17.2 | 19.6 |
| Shore A hardness | 67 | 92 | 75 | 90 | 90 |

1-20. (canceled)

21. A precursor composition for preparing a composition that is curable at 25° C. said precursor comprising a first component (A) separated from a second component (B),
wherein the component (A) comprises
(a1) one or more nitrile-butadiene rubbers, and
(a2) one or more curing agents according to the general formula
R¹R²N—R³—NR⁴H
wherein R¹, R² and R⁴ represent, independently from each other, hydrogen, a linear or branched alkyl or a linear or branched polyoxyalkyl moiety, and wherein R³ represents a linear or branched alkyl, alkylamine, alkylether or polyoxyalkyl residue having at least 5 carbon atoms,
wherein component (B) comprises at least one of
(b1) a silicone resin that has been modified with one or more epoxy resins; or
(b2) (i) an epoxy resin comprising one or more repeating units derived from a dihydric arene; and
(ii) a silicone resin.

22. The precursor composition of claim 21, wherein component (B) comprises (b1) the silicone resin that has been modified with one or more epoxy resins.

23. The precursor composition of claim 21, wherein component (B) comprises (b2)
(i) the epoxy resin comprising one or more repeating units derived from a dihydric arene; and
(ii) the silicone resin.

24. The precursor composition of claim 23, wherein the silicone resin is modified with one or more epoxy resins.

25. The precursor composition of claim 21, wherein R¹, R² and R⁴ represent hydrogen.

26. The precursor composition of claim 25, wherein R³ represents a linear or branched alkylether or polyoxyalkyl residue having at least 5 carbon atoms.

27. The precursor composition of claim 21, wherein the component (B) has a Brookfield viscosity at 25° C. of between about 40 to 200 Pa·s at 25° C. and component (A) has a Brookfield viscosity at 25° C. of between about 40 and 700 Pa·s.

28. The precursor composition of claim 21, which after combining of (A) and (B) and curing at 168 hours at ambient conditions, wherein ambient conditions are 23° C.+/−2° C. and 50%+/−5% humidity, yields a cured composition having, at ambient conditions, at least one of
(a) an elongation at break of at least 100%;
(b) a tear strength of at least 3N/mm;
(c) a shore A hardness of at least 30; and
(d) a tensile strength of at least 0.5 MPa.

29. The precursor composition of claim 21, further comprising aluminium tri hydroxide.

30. A cured composition comprising a cured room-temperature curable mixture comprising component (A) and component (B), wherein
component (A) comprises
(a1) one or more nitrile-butadiene rubbers, and
(a2) one or more curing agents according to the general formula
R¹R²N—R³—NR⁴H
wherein R¹, R² and R⁴ represent, independently from each other, hydrogen, a linear or branched alkyl or a linear or branched polyoxyalkyl moiety, and wherein R³ represents a linear or branched alkyl, alkylamine, alkylether or polyoxyalkyl residue having at least 5 carbon atoms; and
component (B) comprises at least one of
(b1) a silicone resin that has been modified with one or more epoxy resins; or
(b2) (i) an epoxy resin comprising one or more repeating units derived from a dihydric arene; and
(ii) a silicone resin;
wherein the cured composition has an elongation of bream of greater than 100% at ambient conditions, wherein ambient conditions are 23° C.+/−2° C. and 50%+/−5% humidity.

31. The cured composition of claim 30, wherein component (B) comprises (b1) the silicone resin that has been modified with one or more epoxy resins.

32. The cured composition of claim 30, wherein component (B) comprises (b2)
(i) the epoxy resin comprising one or more repeating units derived from a dihydric arene; and
(ii) the silicone resin.

33. The cured composition of claim 32, wherein the silicone resin is modified with one or more epoxy resins.

34. An article comprising a substrate and the cured composition of claim 30 on a surface of the substrate.

35. The article of claim 34, wherein the surface is a wooden surface.

36-37. (canceled)
